(19) United States
(12) Patent Application Publication
(10) Pub. No.: US 2025/0283799 A1
(43) Pub. Date: Sep. 11, 2025

(54) FLUIDIC SYSTEM, SAMPLE PROCESSING INSTRUMENT AND METHOD OF DELIVERING FLUIDS IN A SAMPLE PROCESSING INSTRUMENT

(71) Applicant: Beckman Coulter Biotechnology (Suzhou) Co., Ltd., Jiangsu (CN)

(72) Inventors: Juntao YUAN, Suzhou, Jiangsu (CN); Linqun TANG, Suzhou, Jiangsu (CN)

(73) Assignee: Beckman Coulter Biotechnology (Suzhou) Co., Ltd., Jiangsu (CN)

(21) Appl. No.: 18/862,457

(22) PCT Filed: Jan. 28, 2023
(86) PCT No.: PCT/CN2023/073521

§ 371 Date: Nov. 1, 2024

(30) Foreign Application Priority Data
May 7, 2022 (CN) 202210490617.0

(51) Int. Cl. G01N 15/1409; G01N 15/14; G01N 15/1434

(52) U.S. Cl. CPC G01N 15/1409; G01N 15/1436; G01N 15/1459

(57) ABSTRACT

The present application relates to a fluidic system of a sample processing instrument, a sample processing instrument, and a method of delivering fluids in a sample processing instrument. The sample processing instrument includes a flow cell for passage and processing of a sample. The fluidic system includes: a sheath supply pipeline connecting a sheath container to the flow cell, wherein the sheath supply pipeline is provided with a sheath pump for pumping sheath and a flow sensor for sensing a flow rate of the sheath supplied to the flow cell; a sample supply pipeline connecting a sample container to the flow cell; and a control device configured to control or adjust the flow rate of the sheath to a predetermined value based on the measurement of the flow sensor.

### FIELD

The present application relates to a fluidic system of a sample processing instrument (for example, a flow cytometer or analyzer), a sample processing instrument including the fluidic system and a method of delivering fluids in the sample processing instrument.

### BACKGROUND

This section only provides background information related to the present disclosure, which is not necessarily the prior art.

A sample processing instrument is usually used to analyze a liquid sample including suspended particles (e.g., biological particles, non-biological particles) or cells and/or to sort the particles or cells therein. The stability of fluid (e.g., sample or sheath) delivery may affect the accuracy of the sample processing instrument. If the rate of fluid delivery is substantially constant or stable, the accuracy of the sample processing instrument may be improved. If the rate of fluid delivery changes greatly or is unstable, the accuracy of the sample processing instrument may be decreased. For example, in a sample processing instrument designed for full spectrum, signals may be mixed when the fluid delivery rate changes, thereby reducing accuracy.

A variety of factors can cause changes in fluid delivery rates. For example, if the height of the container in which the fluid is stored changes, the gravitational potential energy may change. For example, peristaltic pumps are used to deliver fluids, which may cause large fluctuations in the fluid. For example, a change in pressure in a fluid may cause a change in the velocity of the fluid.

### SUMMARY

This section provides a general summary of the disclosure and is not a comprehensive disclosure of its full scope or all of its features.

An object of the present application is to provide a fluidic system, a sample processing instrument and a method which can stably deliver a fluid (for example, a sample or sheath) to a flow cell of a sample processing instrument.

According to an aspect of the present application, a fluidic system of a sample processing instrument is provided. The sample processing instrument includes a flow cell for passage and processing of a sample. The fluidic system includes: a sheath supply pipeline connecting a sheath container to the flow cell, wherein the sheath supply pipeline is provided with a sheath pump for pumping sheath and a flow sensor for sensing a flow rate of the sheath supplied to the flow cell; a sample supply pipeline connecting a sample container to the flow cell; and a control device configured to control or adjust the flow rate of the sheath to a predetermined value based on the measurement of the flow sensor.

In some examples according to the present disclosure, the control device is configured to control the sheath pump such that the flow rate of the sheath reaches the predetermined value based on the measurement of the flow sensor.

In some examples according to the present disclosure, the control device is configured to feed the measurement of the flow sensor to the sheath pump.

In some examples according to the present disclosure, the control device is configured to control the sheath pump by controlling a duty cycle.

In some examples according to the present disclosure, a damping device is provided on the sheath supply pipeline, and configured to reduce or eliminate fluctuation of the sheath in the sheath supply pipeline.

In some examples according to the present disclosure, the flow sensor is positioned downstream of the damping device.

In some examples according to the present disclosure, the fluidic system further comprises an inflation pipeline for introducing gas into the damping device.

In some examples according to the present disclosure, the inflation pipeline is provided with a pump and an on-off valve for controlling connection or disconnection of the inflation pipeline.

In some examples according to the present disclosure, the inflation line includes a first pipeline opening to ambient atmosphere and a second pipeline communicating to the sample supply pipeline. The on-off valve is disposed in the first pipeline, and the pump is arranged in the second pipeline.

In some examples according to the present disclosure, the fluidic system further includes a plunger pump and a reversing valve disposed on the sample supply pipeline. The reversing valve is configured to be switched between a first state in which the sample container is communicated to the plunger valve and a second state in which the plunger pump is communicated to the flow cell.

In some examples according to the present disclosure, a degassing device is provided on the sheath supply pipeline, and is configured to eliminate or discharge air bubbles in the sheath.

In some examples according to the present disclosure, the degassing device has a polymer film and is connected to a vacuum pump.

In some examples according to the present disclosure, the degassing device is positioned downstream of the damping device and upstream of the flow sensor.

In some examples according to the present disclosure, the fluidic system further includes a sheath return pipeline for returning a portion of the sheath drawn from the sheath container by the sheath pump to the sheath container.

According to another aspect of the present disclosure, a sample processing instrument including the above fluidic system is provided.

According to still another aspect of the present disclosure, a method of delivering fluids in a sample processing instrument is provided. The method includes the steps of: transporting sheath in the sheath container to a flow cell of the sample processing instrument via a sheath supply pipeline; delivering a sample in the sample container to the flow cell via a sample supply pipeline; sensing a flow rate of sheath in the sheath supply pipeline by a flow sensor; and controlling or adjusting the flow rate of the sheath supplied to the flow cell to a predetermined value based on measurement of the flow sensor.

In some examples according to the present disclosure, controlling or adjusting the flow rate of the sheath to the predetermined value includes controlling the sheath pump such that the flow rate of the sheath reaches the predetermined value.

In some examples according to the present disclosure, controlling or adjusting the flow rate of the sheath to the predetermined value comprises feeding the measurement of the flow sensor to the sheath pump.

In some examples according to the present disclosure, the sheath pump is controlled by controlling a duty cycle.

In some examples according to the present disclosure, the method further includes the step of transporting the sheath in the sheath supply line to flow through a damping device.

In some examples according to the present disclosure, the method further includes the step of introducing gas into the damping device.

In some examples according to the present disclosure, introducing gas into the damping device includes: opening an on-off valve in the inflation pipeline connected to the damping device; aspirating sheath out of the damping device by a pump; and sucking gas into the damping device via the on-off valve.

In some examples according to the present disclosure, the method further includes the step of communicating the damping device to the sample supply pipeline via the pump.

According to another aspect of the present disclosure, the method further includes the step of allowing sheath in the sheath supply pipeline to flow through a degassing device.

In some examples according to the present disclosure, the method further includes the step of enabling the degassing device under vacuum by a vacuum pump.

In some examples according to the present disclosure, the method further includes the step of, before supplying the sample to the flow cell, repeatedly drawing and returning the sample from and into the sample container by a plunger pump provided in the sample supply pipeline.

In some examples according to the present disclosure, the method further includes the step of returning a portion of the sheath drawn from the sheath container by the sheath pump into the sheath container via a sheath return pipeline.

The above and other objects, features and advantages of the present disclosure will be more fully understood from the detailed description given below and the accompanying drawings, which are given by way of illustration only and therefore are not considered to limit the present disclosure.

### BRIEF DESCRIPTION OF THE DRAWINGS

The features and advantages of one or more embodiments of the present disclosure will become more readily understood from the following description with reference to the accompanying drawings in which:

FIG. 1 is a functional block diagram of a sample processing instrument;

FIG. 2 is a functional block diagram of a fluidic system of the sample processing instrument;

FIG. 3 is a schematic diagram of a fluidic system according to an embodiment of the present application;

FIG. 4 is a schematic flow chart of a method of delivering fluid in a sample processing instrument according to an embodiment of the present application;

FIG. 5 is a schematic diagram of a pipeline in which a piston pump is used to suction/push sample from/into a sample container repeatedly;

FIG. 6 is a schematic diagram of a sheath supply pipeline according to an embodiment of the present disclosure;

FIG. 7 is a schematic diagram of a sheath supply pipeline according to another embodiment of the present disclosure;

FIG. 8 is a schematic diagram of a sheath supply pipeline according to a further embodiment of the present disclosure; and

FIG. 9 is a schematic diagram of an inflation pipeline for a damping device according to an embodiment of the present disclosure.

### DETAILED DESCRIPTION OF THE EMBODIMENTS

Hereinafter, the present disclosure is described in detail through exemplary embodiments with reference to the accompanying drawings. In several drawings, similar reference numerals refer to similar parts and components. The following detailed description of the present disclosure is for purposes of illustration only and is in no way limiting of the present disclosure, its application or uses. The implementations described in this specification are not exhaustive and are merely some of many possible implementations. Exemplary embodiments may be embodied in many different forms and should not be construed as limiting the scope of the present disclosure. In some example embodiments, well-known processes, well-known device structures, and well-known technologies may not be described in detail.

Before describing in detail at least one embodiment of the present application, it is to be understood that the present application is not necessarily limited in its application to the details of construction and the arrangement of components set forth in the following description or illustrated in the accompanying drawings. The present application is applicable to other embodiments and combinations of the disclosed embodiments that may be practiced or carried out in various ways. In addition, it is to be understood that the phraseology and terminology employed herein is for the purpose of description and should not be regarded as limiting.

Unless otherwise expressly indicated from the following discussion, it should be understood that throughout the specification, discussion using terms such as “control”, “process”, “calculation”, “determination/judgment” and “obtaining” refers to the actions and/or processes of a computer or computing system or similar electronic computing device, the above actions and/or processes manipulate and convert data represented as physical quantities such as electrons in the registers or memories of the computing system into other data similarly represented as physical quantities in the memories, registers or other such information storage, transmission or display devices of the computing system.

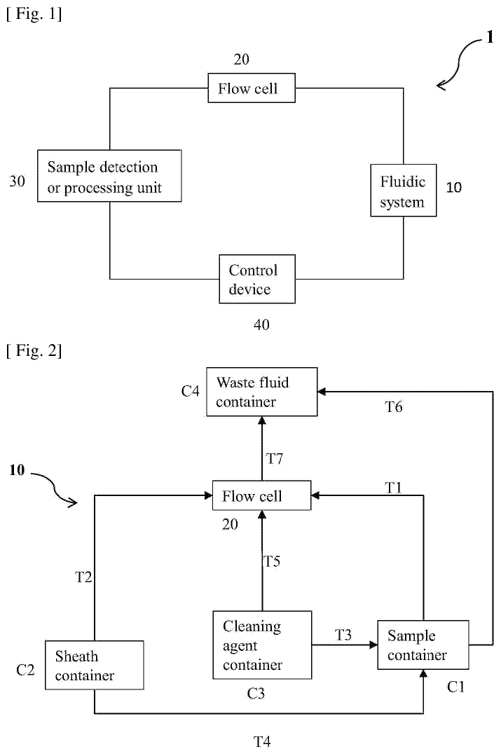

The sample processing instrument I will be described below with reference to FIG. 1. FIG. 1 is a functional block diagram of the sample processing instrument 1. As shown in FIG. 1, the sample processing instrument 1 includes a fluidic system 10, a flow cell 20, a sample detection or processing unit 30, and a control device 40. The sample processing instrument 1 is configured to: deliver the sample into the flow cell 20; detect or process the sample in the flow cell 20 to obtain information about the sample or to sort the sample; and after analyzing or processing the sample, clean the flow cell 20.

The fluidic system 10 includes fluid pipelines for delivering various fluids and various control, regulation, reversing or sensing components (e.g., pumps, valves, pressure regulating devices, sensors, etc.) arranged in the fluid pipelines. The fluids described herein may include samples to be analyzed, sorted or otherwise processed, sheath fluids, cleaning agents, waste fluids, and the like. The cleaning agent may vary depending on the sample. For example, one or more different cleaning agents may be included according to cleaning requirements. The waste fluid refers to fluid that has been treated or cleaned.

Sheath fluid and sample may be supplied into the flow cell 20 via the fluidic system 10. In the flow cell 20, the sample is surrounded by sheath fluid, so that the particles or cells in the sample flow linearly one by one through the detection or processing area.

In the detection or processing area of the flow cell 20, the sample is detected or processed by the sample detection or processing unit 30. For example, the sample detection or processing unit 30 may measure the characteristics of particles/cells in the sample and quantify particles/cells with specific characteristics, and/or the sample detection or processing unit 30 may sort the particles/cells in the sample based on their characteristics. The sample detection or processing unit 30 may include various optical devices, electrical devices, and/or mechanical devices, etc., depending on the purpose of sample processing.

The control device 40 controls the operation of the sample processing instrument 1. Various functions, actions or steps of various systems, devices, components or methods of the sample processing instrument according to the present disclosure are realized under the control of the control device 40. The control device 40 may be a separate control device for each system, device, component or method or an integrated control device.

The fluidic system of the sample processing instrument will be described below with reference to FIG. 2. FIG. 2 is a functional block diagram of the fluidic system 10 of the sample processing instrument. The fluidic system 10 connects various components, systems or units of the sample processing instrument 1 to realize the delivery and control of the fluid. The fluidic system 10 may include fluid pipelines for various fluids and components such as pumps, valves, sensors, etc. disposed in the fluid pipelines.

As shown in FIG. 2, the fluid pipelines of the fluidic system 10 include: a sample supply pipeline T1 connecting a sample container C1 to the flow cell 20 so as to supply the sample in the sample container C1 into the flow cell 20; a sheath supply pipeline T2 connecting a sheath container C2 to the flow cell 20 so as to supply the sheath fluid in the sheath container C2 into the flow cell 20; a sample container cleaning pipeline T3 connecting a cleaning agent container C3 to the sample container C1 so as to clean the sample container C1 with cleaning agent; a sheath cleaning pipeline T4 connecting the sheath container C2 to the sample container C1 so as to clean the sample container C1 with sheath; a flow cell cleaning pipeline T5 connecting the cleaning agent container C3 to the flow cell 20 so as to clean the flow cell 20; a sample waste pipeline T6 connecting the sample container C1 to a waste fluid container C4 so as to discharge waste fluid out of the sample container C1 (for example, fluid after cleaning the sample container C1, etc.); and a flow cell waste pipeline T7 connecting the flow cell 20 to the waste fluid container C4 so as to discharge waste fluid out of the flow cell 20 (for example, samples after being detected or treated, fluids after cleaning the flow cell, etc.). It should be understood that the fluid pipelines T1 to T7 may be completely independent of each other or may have a common pipeline section. Furthermore, it should be understood that the fluid pipelines of the fluidic system 10 may be changed as desired, e.g., by adding additional fluid pipelines or omitting a certain fluid pipeline.

The term “container” as described herein refers to a device used to contain fluids, e.g., glass bottles, well plates, test tubes, plastic cans, or the like.

Furthermore, components such as pumps, valves or sensors (not shown in FIG. 2) may be provided on the fluid pipelines T1 to T7. It should be understood that the components provided on each fluid pipeline may be selected, designed or changed as required.

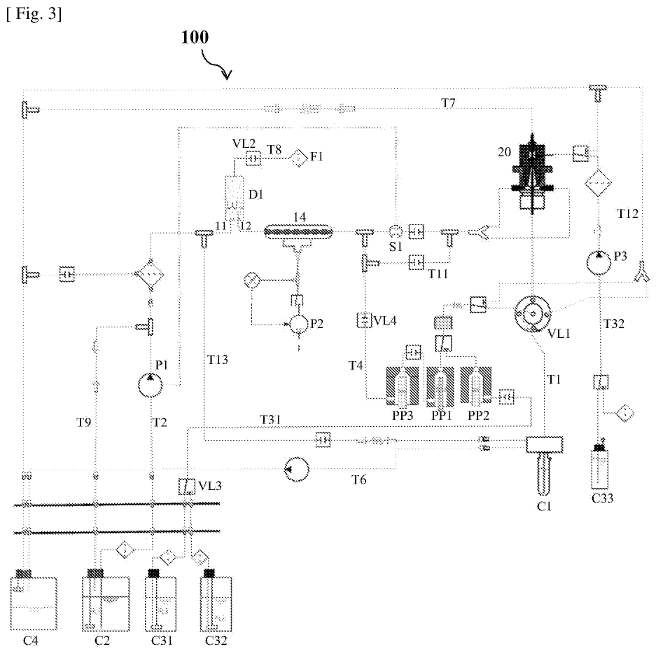

The fluidic system 100 according to an embodiment of the present application will be described in detail below with reference to FIG. 3. FIG. 3 is a schematic diagram of a fluidic system 100 according to an embodiment of the present disclosure. The fluidic system 100 is used to connect various fluid sources (fluid containers) to the flow cell 20 and to connect various fluid sources (fluid containers) to each other, so as to realize or control flow of fluids through the sample processing instrument. In the example of FIG. 3, in addition to the sample container C1, the sheath container C2 and the waste fluid container C4, the sample processing instrument further includes cleaning agent containers C31, C32 and C33 for holding three cleaning agents respectively.

As shown in FIG. 3, the fluidic system 100 includes a sample supply pipeline T1, a sheath supply pipeline T2, cleaning-agent cleaning pipelines T31 and T32, a sheath cleaning pipeline T4, a sample waste pipeline T6 and a flow cell waste pipeline T7, as described above with reference to FIG. 2.

The sample supply pipeline T1 connects the sample container C1 to the flow cell 20. A reversing valve VL1 and a plunger pump PP1 are provided on the sample supply pipeline T1. The reversing valve VL1 is configured to be switched between a first state in which the sample container C1 is communicated to the plunger valve PP1 and a second state in which the plunger pump PP1 is communicated to the flow cell 20.

When the reversing valve VL1 is in the first state to communicate the sample container C1 with the plunger pump PP1, the plunger pump PP1 can suck the sample in the sample container C1 into the sample supply pipeline T1. When the reversing valve VL1 is in the second state to communicate the plunger pump PP1 with the flow cell 20, the plunger pump PP1 can pump the sample in the sample supply pipeline T1 into the flow cell 20. In this way, the sample can be supplied from the sample container C1 into the flow cell 20 by switching the reversing valve VL1.

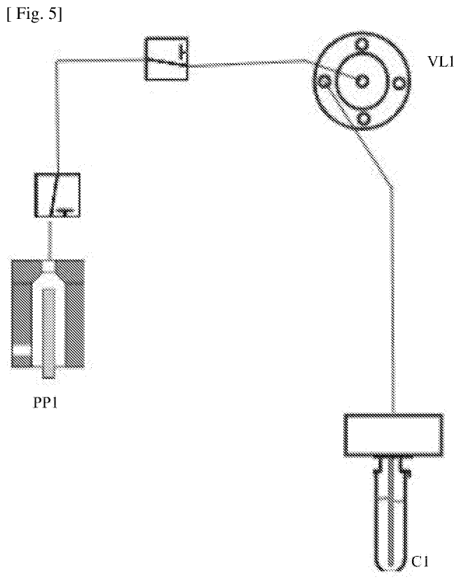

In addition, when the reversing valve VL1 is in the first state to communicate the sample container C1 with the plunger pump PP1, the plunger pump PP1 can suck a sample in the sample container C1 into the sample supply pipeline T1, and then push the sample in the sample supply pipeline T1 back into the sample container C1, as shown in FIGS. 3 and 5. The sucking and pushing actions of the plunger pump PP1 can be repeated several times, so that the sample in the sample container C1 is sufficiently mixed. It is advantageous to mix the sample evenly before sample detection, for example.

In the example of FIG. 3, the reversing valve VL1 is in the form of a rotary valve. It should be understood that the reversing valve VL1 may be means in any other form as long as it can perform the function described herein.

In the example of FIG. 3, a plunger pump PP1 is used. It should be understood that any other suitable type of pump, such as a peristaltic pump, may also be used in place of the plunger pump.

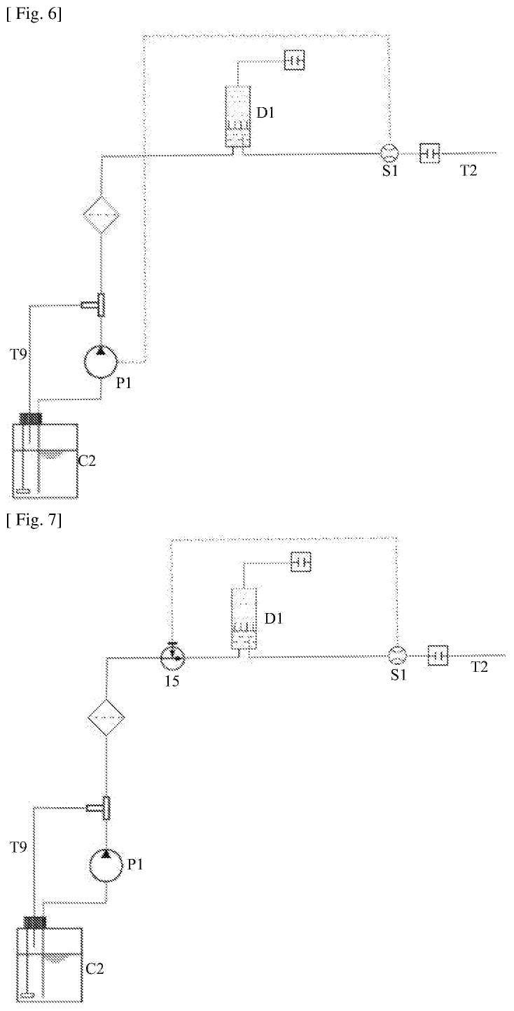

Referring to FIGS. 3 and 6, the sheath supply pipeline T2 connects the sheath container C2 to the flow cell 20. A sheath pump P1 and a flow sensor S1 are provided on the sheath supply pipeline T2. The sheath pump P1 is used to pump the sheath fluid out of the sheath container C2. The pumped sheath fluid may be transported into the flow cell 20 or the sample supply pipeline T1 for sample processing or cleaning. The sheath pump P1 may be any suitable type of pump, e.g., a peristaltic pump, as long as it can perform the function described herein. The flow sensor S1 is configured to sense the flow rate of the sheath fluid to be supplied into the flow cell 20. The flow sensor S1 may be arranged adjacent to the flow cell 20, for example. The measurement of flow sensor S1 (i.e., the measured flow rate of sheath fluid) may be fed back to a control device (e.g., the control device 40 as described above). The control device controls or adjusts the flow rate of the sheath fluid based on the measurement of the flow sensor S1, so that the flow rate of the sheath is substantially constant, for example, a predetermined value.

The sheath pump P1 may be a variable displacement pump. The control device may control or adjust the sheath pump P1 based on the measurement of the flow sensor S1. For example, when the measured flow rate of the sheath fluid is lower or higher than a predetermined value, it is possible to increase or decrease the rotational speed, voltage or the like of the sheath pump P1.

As shown in FIGS. 3 and 6, the control device may feedback the measurement of the flow sensor S1 to the sheath pump P1. The sheath pump P1 may be configured to be automatically adjusted in response to received measurements. The sheath pump P1 may be regulated or controlled by controlling the duty cycle. For example, the rotation speed of the sheath pump P1 may be adjusted by the duty ratio.

It should be understood that the method for controlling or adjusting the flow rate of the sheath fluid shall not be limited to the specific examples shown.

For example, in an example shown in FIG. 7, a throttling device 15 may be provided in the sheath fluid supply line T2. The control device can adjust the opening degree of the throttling device 15 according to the measurement of the flow sensor S1, thereby adjusting the flow rate of the sheath fluid.

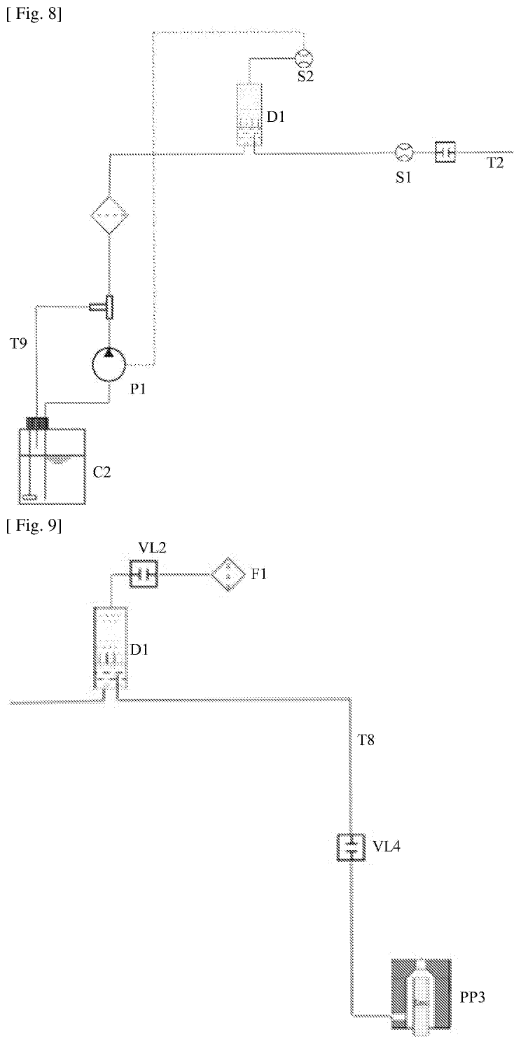

For example, in an example shown in FIG. 8, the control device may vary the flow rate of the sheath fluid by adjusting the pressure in the sheath fluid supply line T2. In this example, a pressure sensor S2 may be provided to sense the pressure of gas in a damping device D1. The sheath pump P1 may be adjusted in the rotational speed by duty cycles, thereby adjusting the pressure of gas in the damping device DI such that the feedback pressure reaches a predetermined constant valve.

The flow sensor S1 can feedback the flow rate of the sheath fluid in real time, and the control device can adjust flow of the sheath fluid automatically and quickly according to the feedback flow rate. The closed-loop control of the flow rate of the sheath fluid can ensure that the sheath fluid is stably supplied to the flow cell 20 at a predetermined flow rate, and the accuracy of the sample processing instrument can be improved.

A damping device D1 may be further provided on the sheath supply pipeline T2. The damping device D1 is configured to reduce or eliminate fluctuations in the sheath fluid through the sheath supply pipeline T2. The damping device D1 may be arranged upstream of the flow sensor S1. That is, the flow sensor S1 is closer to the flow cell 20 in the fluid flow direction than the damping device D1. In this way, the flow rate of the sheath fluid can be controlled more accurately.

In the example of FIG. 3, the damping device D1 is a gas damping device whose damping medium is gas. The damping device D1 has a sheath inlet 11 and a sheath outlet 12. The sheath inlet 11 and the sheath outlet 12 are connected to the sheath supply pipeline T2, so that the sheath fluid coming from the sheath container C1 enters the damping device D1 via the sheath inlet 11 and flows out of the damping device D1 via the sheath outlet 12. The sheath fluid flowing out of the damping device D1 can flow through the flow sensor S1 into the flow cell 20. The damping device D1 is filled with gas (e.g., air). The flow fluctuations of the sheath fluid can be eliminated or reduced under the pressure of the gas.

The fluidic system 100 may further include an inflation pipeline T8 for introducing gas into the damping device D1. Gas can be added to the damping device D1 through the inflation pipeline T8 when necessary to ensure the damping effect on the sheath fluid, that is, eliminating or reducing the flow fluctuation of sheath fluid.

In the example shown in FIGS. 3 and 9, a pump PP3 is provided. The pump PP3 is configured to draw a portion of the sheath fluid out of the damping device D1, whereby drawing gas into the damping device D1. The inflation pipeline T8 may include a first pipeline communicating the ambient atmosphere and the damping device D1 and a second pipeline connecting the damping device D1 and the pump PP3. An on-off valve VL2 and a filter F1 are provided in the first pipeline. In case that gas needs to be supplied to the damping device D1, the on-off valve VL2 is opened to allow gas to pass through the first pipeline and enter the damping device D1. When there is no need to supply gas to the damping device D1, the on-off valve VL2 is closed to prevent the gas from passing through the first pipeline into the damping device D1. The filter F1 is used to filter impurities in the gas so as not to contaminate the sheath fluid.

In the example shown in FIG. 3, the inflation pipeline T8 and the sheath cleaning pipeline T4 share the pump PP3 and have a common pipeline section. The pump PP3 may be connected to the sample supply pipeline T1. As shown in FIG. 3, the pump PP3 may be connected to the sample supply pipeline T1 via the pump PP1. In this way, the pump PP3 can deliver the sheath fluid into the sample container C1 or the flow cell 20 via the sample supply pipeline T1 so as to clean the sample supply pipeline T1 as well as the sample container C1 or the flow cell 20. In the example of FIG. 3, the pump PP3 is in the form of a plunger pump. It should be understood that the pump PP3 may be any other suitable type of pump as long as it can perform the functions described herein.

It should be understood that fluidic systems in accordance with the present application are not necessarily limited to the specific examples illustrated. For example, the inflation pipeline T8 and the sheath cleaning pipeline T4 may have the respective separate pumps and pipeline sections.

A degassing device 14 may be further provided on the sheath supply pipeline T2. The degassing device 14 may be located downstream of the damping device DI. In this way, the degassing device 14 can effectively eliminate or degas the sheath fluid (especially, the sheath fluid discharged from the damping device D1) so as to avoid any air bubbles generated in the fluid pipeline. The degassing device 14 may be located upstream of the flow sensor S1. In this way, the measurement accuracy of the flow sensor S1 can be ensured.

In an example, the degassing device 14 may have a polymer membrane for separating gas, and may be connected to a vacuum pump P2. The vacuum pump P2 creates a vacuum in the degassing device 14, thereby facilitating the discharge of the gas. In an example, the operation of the vacuum pump P2 may be automatically controlled in a closed-loop manner.

The fluidic system 100 may further include a sheath return pipeline T9. The sheath return pipeline T9 connects the sheath supply pipeline T2 to the sheath container C2, so that a part of the sheath fluid flowing in the sheath supply pipeline T2 returns to the sheath container C2. The sheath return pipeline T9 may be connected to the sheath supply pipeline T2 downstream of the sheath pump P1. In this way, the fluctuation caused by the sheath pump P1 pumping sheath fluid can be eliminated or reduced.

The cleaning-agent cleaning pipeline T31 connects the cleaning agent containers C31 and C32 to the sample supply pipeline T1. The cleaning agents in the cleaning agent containers C31 and C32 may be selected as needed. The cleaning agent in the cleaning agent container C31 or C32 can be selectively supplied to the sample supply pipeline T1 through the first sample container cleaning pipeline T31 by the reversing valve VL3.

When the reversing valve VL1 is in the first state to communicate the sample container C1 with the plunger pump PP1, the cleaning agent in the sample supply pipeline T1 can be supplied to the sample container C1 to clean the sample supply pipeline T1 and the sample container C1. At this time, the cleaning-agent cleaning pipeline T31 is used as the sample container cleaning pipeline T3 described with reference to FIG. 2.

When the reversing valve VL1 is in the second state to communicate the flow cell 20 with the plunger pump PP1, the cleaning agent in the sample supply pipeline T1 can be supplied to the flow cell 20 to clean the sample supply pipeline T1 and the flow cell 20. At this time, the cleaning-agent cleaning pipeline T31 is used as the flow cell cleaning pipeline T5 described with reference to FIG. 2.

The cleaning-agent cleaning pipeline T32 connects the cleaning agent container C33 to the flow cell 20. The cleaning agent in the cleaning agent container C33 may be directly supplied into the flow cell 20 via the second sample container cleaning pipeline T32 to clean the flow cell 20. Thus, the cleaning-agent cleaning pipeline T32 is also used as the flow cell cleaning pipeline T5 described with reference to FIG. 2.

A pump PP2 may be provided on the first sample container cleaning pipeline T31. A pump P3 may be provided on the second sample container cleaning pipeline T32. It should be understood that pump PP2 and pump P3 may be any other suitable type of pump, may be the same, or may be different.

It should be understood that fluidic systems in accordance with the present application should not be limited to the specific examples shown in the drawings. For example, various components such as filters, switching devices, and diverting devices may be further provided on the above various fluid pipelines as required. For example, the type, number, location, etc. of the various components on the fluid pipelines may be varied as desired. For example, the fluidic system can add additional fluid pipelines (e.g., a bypass pipeline T11, a discharge pipeline T12 for discharging fluid in the sample supply pipeline into the waste container, or a cleaning pipeline T13 for cleaning the outside of the sample pin with sheath fluid as shown in FIG. 3) or omit a fluid pipeline as needed.

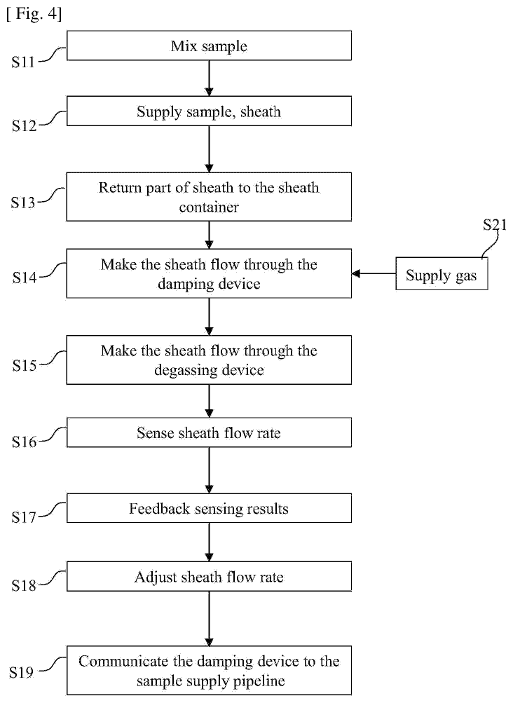

A method of delivering fluids in a sample processing instrument according to the present application will be described below with reference to FIG. 4. FIG. 4 is a schematic flow chart of a method of delivering fluid in a sample processing instrument according to an embodiment of the present application.

As shown in FIG. 4, when the sample processing instrument is running, the sheath fluid and the sample are delivered into the flow cell 20 (step S12). As described above, the sheath fluid in the sheath container C2 is transported to the flow cell 20 of the sample processing instrument 1 via the sheath supply pipeline T2, and the sample in the sample container C1 is transported to the flow cell 20 via the sample supply pipeline T1. Then, the process proceeds to step S16, and the flow rate of the sheath fluid in the sheath supply pipeline T2, that is, the flow rate of the sheath fluid supplied to the flow cell 20 is sensed by the flow sensor S1. The sheath flow rate sensed by the flow sensor S1 may be sent to the control device (step S17). The control device controls or adjusts the flow rate of the sheath fluid supplied to the flow cell 20 to a predetermined value based on the measurement of the flow sensor S1 (step S18). In this way, the fluidic system 100 always delivers sheath fluid into the flow cell 20 at a predetermined flow rate.

In an example, as described above, the measurement of the flow sensor S1 may be fed back to the sheath pump P1, and the sheath pump P1 may be controlled or adjusted so that the flow rate of the sheath fluid reaches a predetermined value or a desired value. In an example, the sheath pump P1 may be controlled by controlling the duty cycle. In this case, the control device may be integrated in the sheath pump P1.

Optionally, before delivering the sample, the sample may be repeatedly drawn from the sample container C1 and returned to the sample container C1 by the plunger pump PP1 and the reversing valve VL1 (step S11). In this way, the sample can be mixed properly prior to detection, thereby improving the efficiency and accuracy of the sample processing instrument.

Optionally, a part of the sheath fluid drawn from the sheath container C2 by the sheath pump P1 may be returned to the sheath container C2 via the sheath return pipeline T9 (step S13). In this way, fluid fluctuations caused by the pumping action of the sheath pump can be eliminated or reduced.

Optionally, the sheath fluid in the sheath supply pipeline T2 may flow through the damping device D1 (step S14). Through the damping effect of the damping device D1, the fluctuation of the sheath fluid can be eliminated or reduced. In an example, as described above, the damping device D1 may be a gas damping device. In this example, gas may be introduced into the damping device (step S21) to ensure the damping effect of the damping device D1. Referring to FIG. 3, when the damping device D1 needs to be inflated, the on-off valve VL2 in the inflation pipeline T8 is opened. The sheath fluid may be pumped from the damping device D1 by the pump PP3 through the second pipeline of the inflation pipeline T8, and the gas is sucked into the damping device DI through the first pipeline of the inflation pipeline T8.

Optionally, the sheath fluid in the sheath supply pipeline T2 may flow through the degassing device 14 (step S15). In an example, the degassing device 14 may be placed under vacuum by a vacuum pump P2 in order to facilitate discharge of the gas. In an example, the vacuum pump P2 may be controlled in a closed loop manner. That is, it is possible to detect the degassing device 14 or the pipeline from the degassing device 14 to the vacuum pump P2, feedback the detection result, and control or adjust the vacuum pump P2 based on the feedback detection result.

Optionally, the damping device D1 may be communicated to the sample supply pipeline T1 via the pump (step S19). As described above, sheath can be drawn from the damping device D1 by the pump PP3. When the damping device D1 is communicated to the sample supply pipeline T1, the extracted sheath fluid can be supplied through the sample supply pipeline T1 to the sample container C1 or the flow cell 20, for example, for cleaning.

It should be understood that the method according to the present application should not be limited to the examples described above and shown in the accompanying drawings, but may varied as required. For example, the various steps of the methods are not necessarily performed in the order described, but can be adjusted as needed without contradiction. For example, the method shown may have additional steps added as desired, or a step omitted.

The above system or method may be implemented by a control device (e.g., the control device 40 shown in FIG. 1). The control device in the present application may include a processor implemented as a computer or a computing system. The method of operating and cleaning the sample processing instrument and the method of monitoring the cleaning of the sample processing instrument described herein may be implemented by one or more computer programs executed by the processor of the computer. A computer program includes processor-executable instructions stored on a non-transitory tangible computer readable medium. The computer program may further include stored data. Non-limiting examples of non-transitory tangible computer-readable media are non-volatile memory, magnetic storage devices, and optical storage devices.

The term computer-readable medium does not include transient electrical or electromagnetic signals propagating through a medium such as on a carrier wave; the term computer readable medium can thus be considered tangible and non-transitory. Non-limiting examples of non-transitory tangible computer-readable medium are non-volatile memory (such as flash memory, erasable programmable read-only memory or mask read-only memory), volatile memory (such as static random access memory circuit or dynamic random access memory), magnetic storage medium (such as analog or digital magnetic tapes or hard drives), and optical storage medium (such as CD, DVD, or Blu-ray Disc).

Although the present application has been described with reference to exemplary embodiments, it should be understood that the present application is not limited to the specific embodiments described and illustrated herein. Without departing from the scope defined by the claims, those skilled in the art can make various changes to the exemplary embodiments. Provided that there is no contradiction, the features in the various embodiments can be combined with each other. Alternatively, a certain feature in the embodiment may also be omitted.

1. A fluidic system of a sample processing instrument comprising a flow cell for passage and processing of a sample,
the fluidic system comprising:
a sheath supply pipeline connecting a sheath container to the flow cell, wherein the sheath supply pipeline is provided with a sheath pump for pumping sheath and a flow sensor for sensing a flow rate of the sheath supplied to the flow cell;
a sample supply pipeline connecting a sample container to the flow cell; and
a control device configured to control or adjust the flow rate of the sheath to a predetermined value based on the measurement of the flow sensor,
wherein a damping device is provided on the sheath supply pipeline, and configured to reduce or eliminate fluctuation of the sheath in the sheath supply pipeline, and
the fluidic system further comprising an inflation pipeline for introducing gas into the damping device, wherein the inflation line comprises a first pipeline opening to ambient atmosphere and a second pipeline communicating to the sample supply pipeline.

2. The fluidic system of claim 1, wherein the control device is configured to control the sheath pump such that the flow rate of the sheath reaches the predetermined value based on the measurement of the flow sensor.

3. The fluidic system of claim 2, wherein the control device is configured to feed the measurement of the flow sensor to the sheath pump and wherein the control device is configured to control the sheath pump by controlling a duty cycle.

4-5. (canceled)

6. The fluidic system of claim 1, wherein the flow sensor is positioned downstream of the damping device.

7. (canceled)

8. The fluidic system of claim 6, wherein the inflation pipeline is provided with a pump and an on-off valve for controlling connection or disconnection of the inflation pipeline.

9. The fluidic system of claim 8, wherein the on-off valve is disposed in the first pipeline, and the pump is arranged in the second pipeline.

10. The fluidic system of claim 9, further comprising a plunger pump and a reversing valve disposed on the sample supply pipeline, wherein the reversing valve is configured to be switched between a first state in which the sample container is communicated to the plunger valve and a second state in which the plunger pump is communicated to the flow cell.

11. The fluidic system of claim 1, wherein a degassing device is provided on the sheath supply pipeline, and is configured to eliminate or discharge air bubbles in the sheath.

12. The fluidic system of claim 11, wherein the degassing device has a polymer film and is connected to a vacuum pump.

13. The fluidic system of claim 11, wherein the degassing device is positioned downstream of the damping device and upstream of the flow sensor.

14. The fluidic system of claim 1, further comprising a sheath return pipeline for returning a portion of the sheath drawn from the sheath container by the sheath pump to the sheath container.

15. A sample processing instrument comprising the fluidic system of claim 1 and a flow cell, wherein a sample and sheath are supplied into the flow cell through the fluidic system.

16. A method of delivering fluids in a sample processing instrument, comprising the steps of:
transporting sheath in the sheath container to a flow cell of the sample processing instrument via a sheath supply pipeline;
delivering a sample in the sample container to the flow cell via a sample supply pipeline;
sensing a flow rate of sheath in the sheath supply pipeline by a flow sensor; and
controlling or adjusting the flow rate of the sheath supplied to the flow cell to a predetermined value based on measurement of the flow sensor;
transporting the sheath in the sheath supply line to flow through a damping device;
introducing gas into the damping device; and
communicating the damping device to the sample supply pipeline via a pump.

17. The method of claim 16, wherein controlling or adjusting the flow rate of the sheath to the predetermined value comprises controlling the sheath pump such that the flow rate of the sheath reaches the predetermined value.

18. The method of claim 17, wherein controlling or adjusting the flow rate of the sheath to the predetermined value comprises feeding the measurement of the flow sensor to the sheath pump; and
wherein the sheath pump is controlled by controlling a duty cycle.

19-21. (canceled)

22. The method of claim 16, wherein introducing gas into the damping device comprises:
opening an on-off valve in the inflation pipeline connected to the damping device;
aspirating sheath out of the damping device by the pump; and
sucking gas into the damping device via the on-off valve.

23. (canceled)

24. The method of claim 16, further comprising:
allowing sheath in the sheath supply pipeline to flow through a degassing device.

25. The method according to claim 24, further comprising:
enabling the degassing device under vacuum by a vacuum pump.

26. The method of claim 16, further comprising:
before supplying the sample to the flow cell, repeatedly drawing and returning the sample from and into the sample container by a plunger pump provided in the sample supply pipeline.

27. The method of claim 16, further comprising:
returning a portion of the sheath drawn from the sheath container by the sheath pump into the sheath container via a sheath return pipeline.
